(19) United States
(12) Patent Application Publication
(10) Pub. No.: US 2015/0278187 A1
(43) Pub. Date: Oct. 1, 2015

(54) SUMMARY-SO-FAR FEATURE FOR ELECTRONIC BOOKS

(71) Applicant: MOHAMED S. ELDAWY, Mountain View, CA (US)

(72) Inventor: MOHAMED S. ELDAWY, Mountain View, CA (US)

(73) Assignee: GOOGLE INC., Mountain View, CA (US)

(21) Appl. No.: 13/456,872

(22) Filed: Apr. 26, 2012

(51) Int. Cl. G06F 17/27; H04L 29/08; G06F 17/30

(52) U.S. Cl. CPC G06F 17/27; G06F 17/30011; G06F 17/30312; H04L 67/10

(57) ABSTRACT

An electronic book reader system is configured to provide a partial summarization of an electronic book, the electronic book being made up of a plurality of portions. A plurality of summaries are generated, each corresponding to a different subset of the plurality of portions of the electronic book. An indication of a specific subset of the plurality of portions that a user has read is used to select one or more of the plurality of summaries. The partial summarization is prepared from the selected one or more summaries and the partial summarization is presented to the user.

### TECHNICAL FIELD

The disclosure relates generally to the field of electronic media, and specifically to electronic book summarization.

### BACKGROUND

Reading a book involves a significant investment of time by a reader. As a result, it may take a reader many sittings over weeks, months, or even years to complete a particular book. Thus, a reader may forget important information about characters, place, items, and events within the book. Further, many readers undertake reading multiple books at the same time, making it even harder to remember what has already been read. For example, a reader may forget when reading fantasy book “The Lord of the Rings” that Galadriel is Arwen's grandmother.

Searching back through a book to reread information can significantly add to the amount of a time a reader has to invest in reading the book. Instead of rereading portions of the book, a reader may attempt to discover the information by searching the Internet. However, this approach exposes the user to the risk of discovering information about portions of the book they haven't read, as well as the information they were looking for, as internet resources are generally sorted by entity (e.g., person, place, thing, etc.) rather than by the order in which they occur in the book.

### SUMMARY

A computer-implemented method for providing a “summary-so-far” feature for an electronic book is disclosed. In one aspect, the electronic book includes a start point and a plurality of break points and the method includes receiving a plurality of summaries, with each summary describing the content of the electronic book between the start point and a respective break point. The method further includes comparing a current reading position with the plurality of break points and selecting one of the summaries responsive to the comparing.

In another aspect, the electronic book includes a plurality of portions and the method includes receiving a plurality of summaries where each summary corresponds to a different subset of the plurality of portions. An indication of which of the portions a user has read is also received. One of the plurality of summaries is selected based on the indication of which portions the user has read and the selected summary is prepared for presentation to the user.

In one aspect, the comparing comprises searching between the current reading position and the start point and selecting a break point that is closest to the current reading position based on the searching. In another aspect, a subset of the plurality of summaries is created by one or more human users.

In yet another aspect, the method further includes applying an automatic summarization algorithm to the electronic book to generate a subset of the plurality of summaries and storing the plurality of summaries in a computer-readable storage medium. In a related aspect, the method further includes receiving feedback corresponding to one or more of the summaries, and in a further related aspect the automatic summarization algorithm is a machine learning algorithm that is configured to take the feedback as input. In a further aspect, the method further includes revising the plurality of summaries responsive to user input.

A computer system for providing a “summary-so-far” feature for an electronic book made up of a plurality of portions is also disclosed. In one aspect, the system includes a data store, a summarization module, and a presentation module. The summarization module is configured to generate a plurality of summaries and store the summaries in the data store, with each summary corresponding to a different subset of the plurality of portions. The presentation module is configured to receive an indication of which of the plurality of portions a user has read, and to select a corresponding one of the plurality of summaries based on the indication.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level block diagram illustrating a networked computing environment for providing a “summary-so-far” feature, consistent with one embodiment.

FIG. 2 is a high-level block diagram illustrating an example of a computer for use in the computing environment shown in FIG. 1.

FIG. 3 is a high-level block diagram illustrating a client device suitable for use in the networked computing environment shown in FIG. 1, according to one embodiment.

FIG. 4 is a high-level block diagram illustrating the summary subsystem of the cloud provider facility of FIG. 1, according to one embodiment.

FIG. 5 is a flowchart illustrating a method for providing a “summary-so-far” feature, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

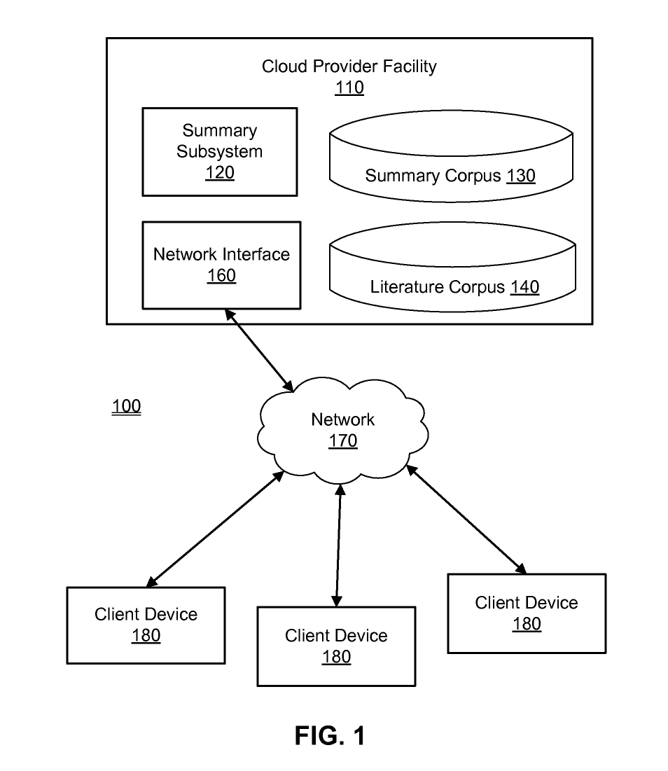

It would be advantageous to readers to provide a system enabling easy access to a summary of the sections of a book a reader has already been read, without exposing the reader to information about sections the reader has not read, which might spoil the reader's enjoyment of the book. FIG. 1 shows a networked computing environment 100 for providing such a “summary-so-far” feature for electronic books, consistent with one embodiment. The networked computing environment 100 includes a cloud provider facility 110 and a plurality of client devices 180, of which three are shown for exemplary purposes only. The client devices 180 and cloud provider facility are connected by a network 170.

The cloud provider facility 110 makes books that can be viewed on the client devices 180 available for purchase, licensing, rental, subscription and/or free download. In addition, the cloud provider facility 110 provides summaries of a portion of a book between a start point and a break point that the reader has already reached in the book. The break points may be chapter breaks, page breaks, paragraph breaks, and the like. For example, in one embodiment, if a user last stopped reading in the middle of chapter four of a book and requests a “summary-so-far”, the cloud provider facility 110 will provide a summary of chapters one, two and three. In other embodiments, the summary provided will include content from the book right up to the paragraph or word at which the reader previously stopped reading.

The network 170 is typically the Internet, but can be any network, including, but not limited to, any combination of a LAN, a MAN, a WAN, a mobile, a wired or wireless network, a private network, or a virtual private network. The cloud provider facility 110 is connected to the network 170 through a network interface 160.

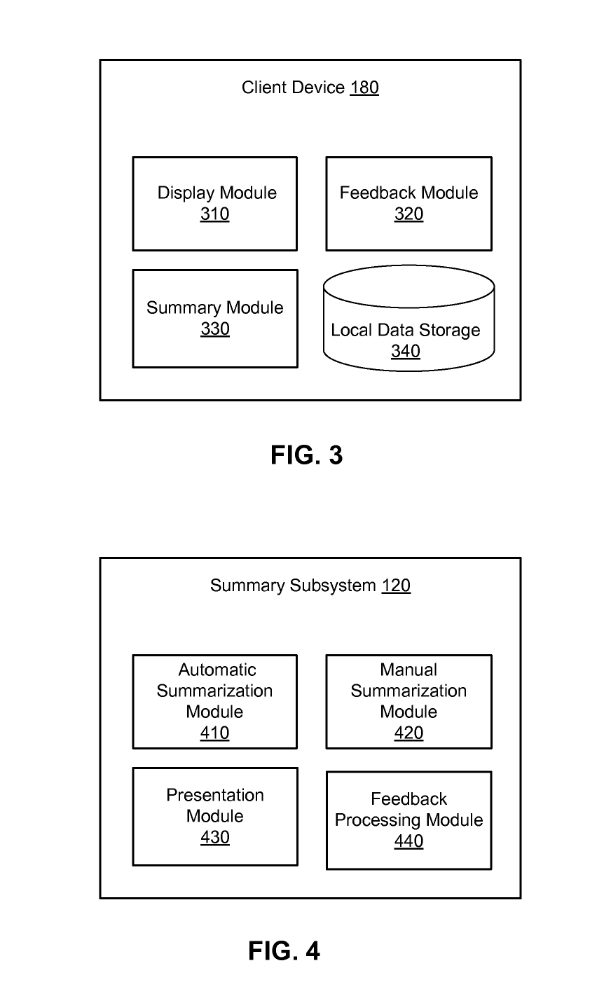

The client devices 180 can be any computing device capable of displaying an electronic book to a user, such as desktop PCs, laptops, smartphones, PDAs, electronic book readers, and the like. As discussed above, although only three client devices 180 are shown, in practice there are many (e.g., millions of) client devices 180 that can communicate with and the cloud provider facility 110 using the network 170. An exemplary client device is described in greater detail below, with reference to FIG. 3.

In the illustrated embodiment, the cloud provider facility 110 includes a summary subsystem 120, a network interface 160, a summary corpus 130 and a literature corpus 140. The network interface 160 enables the various components of the cloud provider facility 110 to communicate with each other internally, as well as with the client devices 180 via the network 170. Other embodiments of the cloud provider facility 110 include different and/or additional components. In addition, the functions may be distributed among the components in a different manner than described herein.

The literature corpus 140 comprises one or more data storage devices that hold a collection of electronic books that are available for access from client devices 180. As used herein, the term electronic book should be taken to include all forms of media object with at least one narrative or experiential thread running throughout, including, but not limited to: electronic books; movies; and any other such entity. In some embodiments, metadata is embedded in all or some of the electronic books. The term metadata is used herein to encompass all data corresponding to a book that is available in the computing environment 100.

The summary corpus 130 comprises one or more data storage devices (which may be the same devices that make up the literature corpus 140) that hold summaries of portions of books from the literature corpus 140. In one embodiment, the summary corpus 130 contains as set of summaries for each book in the literature corpus 140. The set of summaries for a book comprises summaries describing the content of the book from a start point to each of a plurality of break points throughout the book. As described above, in different embodiments, the break points are distributed over one or more different scales, such as every chapter, every page and/or every paragraph.

The summary subsystem 120 generates and provides summaries-so-far for books for presentation to users at one or more of the client devices 180. When the cloud provider facility 110 receives a request for a “summary-so-far” from a client device 180, the summary subsystem selects a summary from the summary corpus 130 based on the specific book and a current reading position associated with the client device. The selected summary is sent via network 170 to the client device 180 for presentation. The summary subsystem is described in greater detail below, with reference to FIG. 4.

In some embodiments, the cloud provider facility 110 also collects and stores user data (not shown) such as a reading history associated with a user and current reading positions in one or more books. The storage of current reading positions and reading history as part of user account data enables, amongst other things, the cloud provider facility 110 to provide summary information for only portions of the book that the user has already read even if the user is using a different one of the client devices 180. In one such embodiment, the user is notified of the intention to collect usage data and given an option to opt-out before any data is collected.

In one embodiment, if a user is re-reading some or all of a book (indicated by a current reading position at an earlier point in the book than the user's reading history indicates the user has read up to) the user is provided with an option for the “summary-so-far”to include information for all the portions the user has previously read, or only the portions prior to the current reading position.

### Computing System Architecture

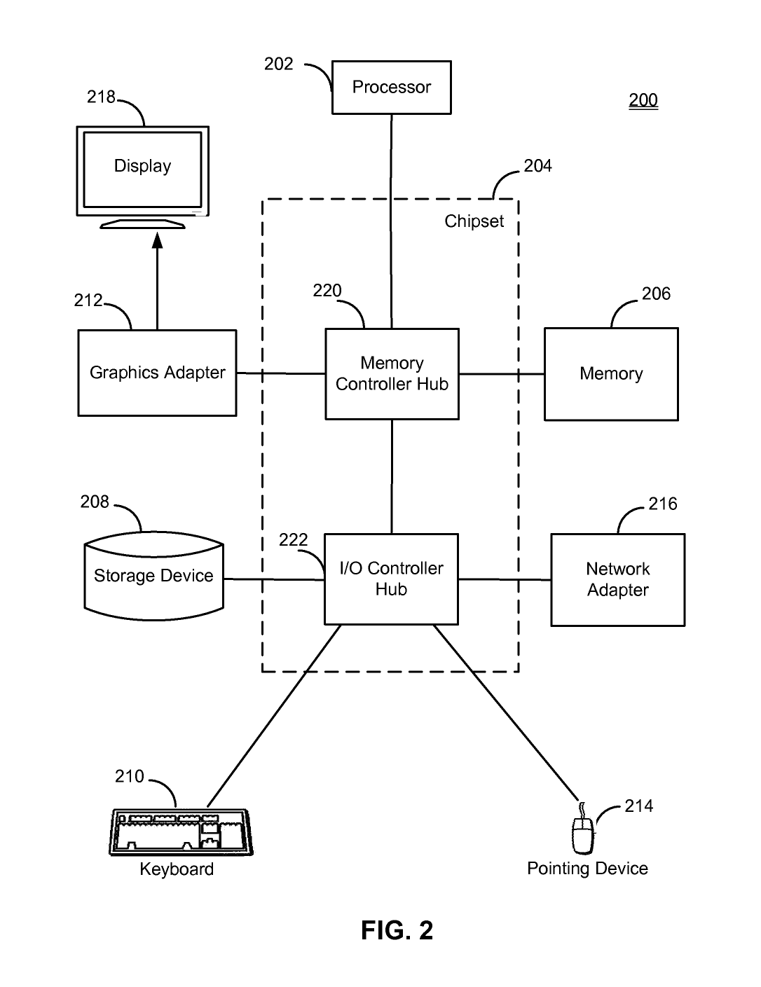

The entities shown in FIG. 1 are implemented using one or more computers. FIG. 2 is a high-level block diagram illustrating an example computer 200. The computer 200 includes at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display 218 is coupled to the graphics adapter 212. A storage device 208, keyboard 210, pointing device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer system 200. The graphics adapter 212 displays images and other information on the display 218. The network adapter 216 couples the computer system 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202.

The types of computers used by the entities of FIG. 1 can vary depending upon the embodiment and the processing power required by the entity. For example, the cloud provider facility 110 might comprise multiple blade servers working together to provide the functionality described herein, whereas client devices 180 might be tablet computing devices. The computers can lack some of the components described above, such as keyboards 210, graphics adapters 212, and displays 218.

### System Details

FIG. 3 is a high-level block diagram illustrating a client device 180 suitable for presenting an electronic book and a “summary-so-far” to a user, according to one embodiment. The client device 180 shown includes a display module 310, a feedback module 320, a user summary module 330, and local data storage 340. Other embodiments of client devices 180 include different and/or additional modules. In addition, the functions may be distributed among the modules in a different manner than described herein.

The display module 310 receives at least part of an electronic book and presents it to the user on a screen. Alternatively, the display module 310 presents the electronic book in audio form using either text to speech or a pre-recorded narration. In one embodiment, the user has pre-downloaded the electronic book from the cloud provider facility (e.g., by purchasing the electronic book from GOOGLE PLAY STORE™) and the display module 310 accesses the electronic book from local data storage 340. In another embodiment, the display module 310 directly accesses a remote copy of the book stored in the literature corpus 140, via the network 170.

The summary module 330 processes requests made by the user via user input into the client device 180 for a “summary-so-far” for a book currently being displayed by the display module 310. In various embodiments, the summary module 330 determines the user's current position in the electronic book by examining one or more of the following pieces of information: the portion of the electronic book currently displayed; user data in local data storage 340; and user data stored in the cloud provider facility 110.

In one embodiment, the summary module 330 searches back from the current position to identify the last break point within the electronic book that the user has reached. The summary module 330 obtains a summary of the portions of the electronic book between the beginning of the electronic book and the identified break point from the summary corpus 130.

The summary can be in any form appropriate for presentation to the user at the client device 180. For example, the summaries can include one or more of: text, audio recordings, pictures, videos, and the like. The display module 310 presents the summary to the user in a suitable manner for the type of content included in the summary, such as displaying text on a screen of the client device 180 or playing audio files using one or more speakers connected to the client device. In some embodiments, the display module 310 converts summaries from one format to another to present them to the user in a desired format. For example, in one such embodiment, the display module 310 utilizes speech to text technology to present an audio summary to the user as written text.

The feedback module 320 collects feedback from the user regarding summaries-so-far provided by the summary module 330. In some embodiments, the feedback module 320 provides user controls on a screen of a client device 180 enabling the user to provide rating information for the summary, such as a score from a scale of 1 to 5, or a “+1” indicating a summary is of a high quality. In other embodiments, the feedback module 320 provides user controls for the user to suggest amendments to the summary. The processing of user provided feedback is described in greater detail below with reference to FIG. 4.

Referring now to FIG. 4, a high-level block diagram is shown, illustrating the summary subsystem 120 of the cloud provider facility 110, according to one embodiment. In the embodiment shown, the summary subsystem 120 comprises an automatic summarization module 410, a manual summarization module 420, a presentation module 430, and a feedback processing module 440. Other embodiments of the analysis module 110 include different and/or additional modules. In addition, the functions may be distributed among the modules in a different manner than described herein.

The automatic summarization module 410 applies summarization algorithms to electronic books in the literature corpus 140 to automatically generate summaries for inclusion in the summary corpus 130. One such algorithm is described in “Sumatra: A system for Automatic Summary Generation” by D. H. Lie (Carp Technologies, 1998), which is incorporated herein by reference in its entirety.

In one embodiment, the automatic summarization module 410 generates a plurality of summaries for each electronic book in the literature corpus 140. To generate the plurality of summaries for an electronic book, the automatic summarization module 410 considers a start point and a plurality of break points within the electronic book. The start point is generally the start of the electronic book, but other embodiments may use start points positioned after introductory pages, such as those containing a list of contents, forwards, and publishing information. Use of start points is particularly appropriate for books containing a number of independent works, such as a book of several unrelated stories, each of which may still be a number of chapters in length. As described above in reference to FIG. 1, the break points are variously defined by chapter breaks, page breaks, paragraph breaks, and the like, depending on the specific embodiment.

The automatic summarization module 410 applies a summarization algorithm to subsets of the electronic book's content defined by the start point and one of the break points. For example, in an electronic book with three chapters where the chapter breaks are used as break points, the automatic summarization module 410 produces three summaries and stores them as part of the summary corpus 130. The first summary describes chapter one, the second, chapters one and two, and the third, chapters one through three. In this manner, no matter how many chapters the user has completed, the summary corpus 130 contains a single summary describing what the reader has previously read.

In an alternative embodiment, the automatic summarization module 410, rather than generating summaries based on a single start point, determines a plurality of portions of an electronic book that the user has completed. This is particularly useful for text books, where users often read the chapters out of order, or skip over chapters. In this embodiment, rather than producing summaries of the electronic book from a start point up to each of a plurality of break points, the automatic summarization module 410 generates summaries of all possible combinations of the portions of the electronic book. For example, in the previous example of a book where the portions are chapters and the electronic book has three chapters in total, the automatic summarization module 410 generates seven summaries: three that describe the individual chapters; three that describe all possible combinations of two chapters from the three; and one that describes all three chapters.

The manual summarization module 420 provides an interface for users to provide summaries of subsets of the content of electronic books. In some embodiments, the interface is accessed within the cloud provider facility 110 by one or more system administrators. In other embodiments, users log in from client devices 180 to access the interface remotely via network 170.

In one embodiment, the manual summarization module 420 receives summaries generated by the automatic summarization module 410 and presents them to a human operator. The operator reviews the summary and is given the option to approve the summary, amend the summary, or provide an entirely new summary. Whichever option is chosen, the resulting operator approved summary is added to the summary corpus 130.

In another embodiment, summaries are provided entirely by human operators using an interface provided by the manual summarization module 420. In this case, an operator selects an electronic book as well as what to use to define break points (chapters, pages, paragraphs, etc.) and whether summaries should be defined from a single start point or for all possible combinations of portions of the electronic book. The manual summarization module 420 then prompts the operator to enter a summary for each subset of the electronic book's content, as defined by the break points.

The presentation module 430 processes requests received from client devices 180 for a “summary-so-far.” In one embodiment, the requests include an indication of a specific electronic book within the literature corpus 140 and a user's current reading position within the electronic book. The presentation module 430 uses the current reading position to identify the last break point the user reached and provides the corresponding summary from the summary corpus 130 for display at the client device 180. In other embodiments, the presentation module 430 uses other methods to select a summary from the summary corpus 130. For example, the presentation module 430 may provide the summary that includes the portion of the electronic book that the current reading position is within, or may do so only if the current reading position is more than halfway through the portion.

In another embodiment, the request for a “summary-so-far” also includes user preferences regarding summary type and format. For example, a user may configure a client device 180 to automatically request summaries that are in audio form. On receiving such a request, the presentation module 430 provides an audio summary if one is available. The user preferences further indicate whether a summary in another format should be provided if no summary in the preferred format is available, or whether the presentation module 430 should return an error to the client device 180 indicating that no summary is available. Alternatively, the presentation module 430 is configured to convert a summary into the requested type, such as by applying a text to speech algorithm.

The feedback processing module 440 receives feedback entered via the feedback modules 320 of client devices 180. In one embodiment, the feedback received is in the form of crowd sourced ratings for summaries that the cloud provider facility 110 has provided to client devices 180. The feedback processing module 440 uses machine learning techniques to adjust the summarization algorithms used by the automatic summarization module 410 based on the received feedback. Thus, the quality of summary provided by the automatic summarization module 410 is improved over time.

In a related embodiment, the feedback processing module 440 aggregates received ratings for presentation to human operators (e.g., system administrators for the cloud provider facility 110). This enables the human operators to more easily identify summaries that merit improvement. Once a human operator has identified a summary in need of improvement, the manual summarization module 420 provides an interface with which the human operator can access the summary and either amend or replace it.

In other embodiments, the feedback processing module 440 utilizes feedback received from users to modify the summaries directly. In one such embodiment, feedback processing module 440 is configured to present the summary corpus 130 like a wiki at a client device 180. Thus, a user can browse the summaries and make amendments that are automatically entered into the summary corpus 130. In a related embodiment, the summary subsystem 120 of the cloud provider facility 110 sends amendments entered by a user to one or more system administrators for review. If the amendment is approved, the summary subsystem 120 enters the amendment into the summary corpus 130.

### Exemplary Method

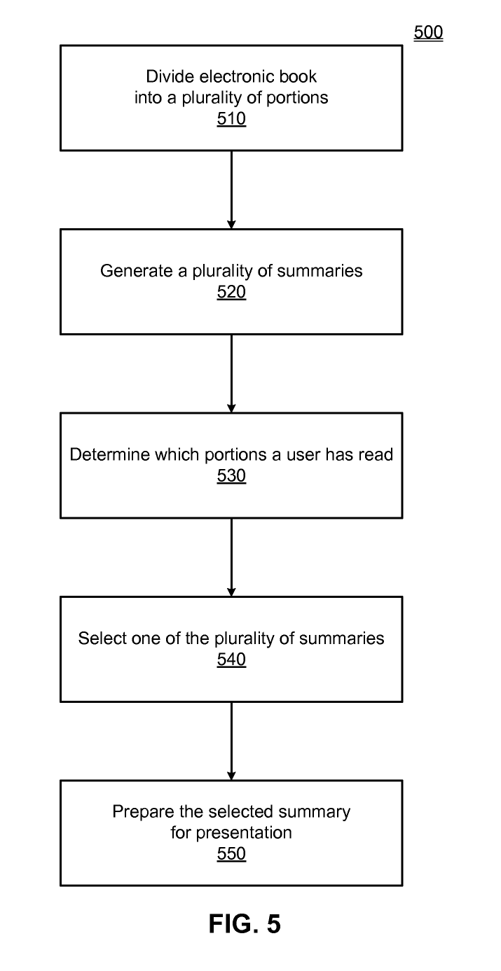

Turning now to FIG. 5, a flowchart is shown illustrating a method 500 for providing a “summary-so-far” feature for an electronic book, according to one embodiment. FIG. 5 attributes the steps of the method to the summary subsystem 120. However, some or all of the steps may be performed by other entities. In addition, some embodiments may perform the steps in parallel, perform the steps in different orders, or perform different steps.

At step 510, the summary subsystem 120 divides the electronic book into a plurality of portions. As described previously with regards to FIG. 1, these portions can be chapters, pages, paragraphs, and the like, depending on the specific embodiment. In some embodiments dividing the electronic into a plurality of portions is merely involves reading metadata associated with the electronic book that identifies appropriate break points that have been previously determined.

At step 520, the summary subsystem 120 generates a plurality of summaries corresponding to subsets of the portions of the electronic book. For books that contain a single narrative (i.e., where it makes little sense to read the portions out of order), summaries are ordinarily generated for subsets that correspond to all portions between the start of the book and one of the identified break points. For certain types of book (e.g., textbooks and collections of short stories) it may be preferable for a user to read the portions out of order. In one embodiment, such cases are accounted for by generating summaries of all possible combinations of the identified portions.

At step 530, the summary subsystem 120 determines which of the portions of the electronic book a user has already read. In the case of books with a single narrative described above, this can be achieved by comparing an indication of the user's current position with the positions of the break points between portions, as described above with reference to FIG. 3. Once a break point corresponding to the current reading position has been determined, the summary subsystem 120 assumes that all portions previous to that have been read by the user, and all portions following that have not. Alternatively, in the case of books in which the reading order of the portions is less well defined, the summary system 120 relies on user data to determine which portions the user has read, as described above with reference to FIG. 3.

At step 540, the summary subsystem 120 selects one of the plurality of summaries based on which portions the user has read. In general, the summary selected will summarize just the portions that the user has read. In some embodiments, the summary subsystem 120 provides user controls with which the user can partially or wholly override the determination made by the summary subsystem. For example, the user can elect to see a summary of the whole book, even if the user has only read the first half of the book.

At step 550, the summary subsystem 120 prepares the selected summary for presentation to the user at their client device 180. In some embodiments preparing the summary merely comprises sending the summary via network 170 to the requesting client device 180. In other embodiments, the summary obtained from the summary corpus 130 is processed to convert the summary into a format more appropriate for presentation at the requesting client device 180. Such processing may include performing text to speech conversion, performing speech to text conversion, converting between file formats, changing a video aspect ratio, and any other such processing that enables more efficient presentation of the summary by client device 180.

### Additional Considerations

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module.

In an embodiment where the modules as implemented by software, they are stored on a computer readable persistent storage device (e.g., hard disk), loaded into the memory, and executed by one or more processors included as part of a client device 180 and/or cloud provider facility 110. Alternatively, hardware or software modules may be stored elsewhere within the networked computing environment 100. The networked computing environment 100 includes hardware elements necessary for the operations described here, including one or more processors, high speed memory, hard disk storage and backup, network interfaces and protocols, input devices for data entry, and output devices for display, printing, or other presentations of data.

Numerous variations from the system architecture of the illustrated computing environment 100 are possible. The components of the environment 100 and their respective functionalities can be combined or redistributed. For example, the literature corpus 140 can be distributed among any number of physical devices.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for providing a “summary-so-far” feature. Thus, while particular embodiments and applications have been illustrated and described, it is to be understood that the present disclosure is not limited to the precise construction and components disclosed herein and that various modifications, changes and variations which will be apparent to those skilled in the art may be made in the arrangement, operation and details of the method, system, and storage medium disclosed herein without departing from the spirit and scope as defined in the appended claims.

1. A computer-implemented method for summarizing an electronic book, the electronic book having a start point and a plurality of break points, the method comprising:
generating a plurality of summaries, each summary describing content of the electronic book between the start point and a respective break point;
comparing a current reading position with the plurality of break points;
selecting a first subset of the plurality of summaries responsive to the comparing;
preparing a partial summarization of the electronic book from the first subset; and
presenting a user control configured to enable a user to provide rating feedback for the partial summarization.

2. The method of claim 1, wherein a second subset of the plurality of summaries is created by one or more human users.

3. The method of claim 1, wherein generating the plurality of summaries comprises:
applying an automatic summarization algorithm to the electronic book to generate a second subset of the plurality of summaries; and
storing the plurality of summaries in a computer-readable storage medium.

4. The method of claim 3, further comprising:
receiving user-suggested amendments corresponding to one or more of the summaries.

5. The method of claim 3, wherein the automatic summarization algorithm is a machine learning algorithm configured to take the rating feedback as input.

6. A computer system for summarizing an electronic book comprising a plurality of portions, the computer system comprising:
a data store;
a summarization module, configured to generate a plurality of summaries and store the summaries in the data store, each summary corresponding to a different subset of the plurality of portions; and
a presentation module, configured to receive an indication of a specific subset of the plurality of portions, the specific subset containing portions determined to have been read by a user, and further configured to select a first subset of the plurality of summaries based on the indication, prepare a partial summarization of the electronic book from the first subset, and present a user control configured to enable a user to provide rating feedback for the partial summarization.

7. The computer system of claim 6, wherein the specific subset comprises all portions prior to a current reading position associated with the user for the electronic book.

8. The computer system of claim 6, wherein the summarization module generates a second subset of the plurality of summaries responsive to user input by one or more human users.

9. The computer system of claim 6, wherein the summarization module generates a second subset of the plurality of summaries by applying an automatic summarization algorithm to the electronic book.

10. The computer system of claim 9, further comprising a feedback module configured to receive the rating feedback, wherein the automatic summarization algorithm is a machine learning algorithm configured to take the rating feedback as input.

11. The computer system of claim 9, further comprising a feedback module configured to amend one or more of the plurality of summaries responsive to user input.

12. The computer system of claim 11, wherein the user input comprises one or more ratings, each rating corresponding to one of the plurality of summaries.

13. The computer system of claim 11, wherein the user input comprises one or more replacement summaries, and the amending comprises, for each replacement summary, replacing a corresponding one of the plurality of summaries in the data store.

14. A computer-implemented method for summarizing an electronic book, the electronic book having a plurality of portions, the method comprising:
generating a plurality of summaries, each summary corresponding to a different subset of the plurality of portions;
receiving an indication of a specific subset of the plurality of portions, the specific subset containing portions determined to have been read by a user;
selecting a first subset of the plurality of summaries responsive to the indication;
preparing a partial summarization of the electronic book from the first subset for presentation at a computing device associated with the user; and
presenting a user control configured to enable a user to provide rating feedback for the partial summarization.

15. The method of claim 14, wherein the specific subset comprises all portions prior to a current reading position associated with the user for the electronic book.

16. The method of claim 14, wherein a second subset of the plurality of summaries is created by one or more human users.

17. The method of claim 14, wherein generating a plurality of summaries comprises:
applying an automatic summarization algorithm to the electronic book to generate a second subset of the plurality of summaries; and
storing the plurality of summaries in a computer-readable storage medium.

18. The method of claim 17, further comprising revising the plurality of summaries responsive to user input provided via the user control.

19. The method of claim 17, further comprising:
receiving user-suggested amendments corresponding to one or more of the plurality of summaries.

20. The method of claim 19, wherein the automatic summarization algorithm is a machine learning algorithm configured to take the rating feedback as input.

21. A computer system for presenting a summary of an electronic book, the electronic book comprising a plurality of portions, the computer system comprising:
a summary subsystem configured to determine a subset of the plurality of portions, the subset of the plurality of portions corresponding to portions a user has read;
a network interface configured to receive a partial summary of the electronic book responsive to sending an indication of the subset of the plurality of portions, the partial summary corresponding to the subset of the plurality of portions; and
a display module configured to present the partial summary and a user feedback control, using an output device of the computer system.

22. The computer system of claim 21, wherein the summary subsystem is further configured to determine a current reading position associated with the electronic book and the subset of the plurality of portions comprises all portions prior to the current reading position.

23. The computer system of claim 21, further comprising a feedback module configured to provide the user feedback control, the user feedback control enabling the user to provide feedback corresponding to the partial summary.

24. The computer system of claim 23, wherein the feedback comprises a rating.

25. The computer system of claim 23, wherein the feedback comprises an amendment to the partial summary.

26. The computer system of claim 21, wherein the output device is a display.

27. The computer system of claim 21, wherein the output device is one or more speakers.

28. The computer system of claim 27, wherein the partial summary is text and the display module is further configured to apply a text to speech algorithm to the partial summary.

29. A computer-implemented method for summarizing an electronic book, the electronic book having a start point and a plurality of break points, the method comprising:
receiving a plurality of summaries, each summary describing content of the electronic book between the start point and a respective break point;
comparing a current reading position with the plurality of break points;
selecting a first subset of the plurality of summaries responsive to the comparing;
preparing a partial summarization of the electronic book from the first subset; and
presenting a user control configured to enable a user to provide rating feedback for the partial summarization.

30. The method of claim 29, wherein the comparing comprises:
searching between the current reading position and the start point; and
selecting, based on the searching, a break point that is closest to the current reading position.

31. The method of claim 29, further comprising revising the plurality of summaries responsive to user input obtained via the user control.
